(19) United States
(12) Patent Application Publication
(10) Pub. No.: US 2016/0055310 A1
(43) Pub. Date: Feb. 25, 2016

(54) DETERMINATION OF POTENTIALLY PREVENTABLE HEALTHCARE EVENTS

(71) Applicant: 3M INNOVATIVE PROPERTIES COMPANY, Saint Paul, MN (US)

(72) Inventors: Linda A. Bentley, Durham, CT (US); Richard F. Averill, Seymour, CT (US); Richard L. Fuller, Pasadena, MD (US); Norbert I. Goldfield, Northampton, MA (US); Elizabeth C. McCullough, Silver Spring, MD (US); Caroline R. Piselli, Branford, CT (US); James C. Vertrees, Annapolis, MD (US)

(21) Appl. No.: 14/888,096

(22) PCT Filed: Apr. 30, 2014
(86) PCT No.: PCT/US2014/036062

§ 371 Date: Oct. 30, 2015

Related U.S. Application Data
(60) Provisional application No. 61/818,119, filed on May 1, 2013.

(51) Int. Cl. G06F 19/00

(52) U.S. Cl. CPC G06F 19/3431; G06F 19/322; G06F 19/3443

(57) ABSTRACT

In one embodiment, the invention is directed to a method of processing patient healthcare data, via one or more computers. In some examples, the method comprises receiving, at the one or more computers, patient healthcare data, wherein the patient healthcare data represents a healthcare event and includes one or more healthcare codes. The method may further comprise determining, by the one or more computers and based on the one or more healthcare codes, one or more patient factors associated with the healthcare event. The method may also comprise determining, by the one or more computers and based on the one or more healthcare codes and the one or more patient factors associated with the healthcare event, whether the healthcare event is a potentially preventable healthcare event, wherein the healthcare event comprises one of: an inpatient admission, an emergency room visit, and an outpatient ancillary service.

### TECHNICAL FIELD

The invention relates to classifying healthcare events.

### BACKGROUND

In the healthcare field, healthcare providers provision the use of medical care based on the needs of the patients. Many different factors affect the prescribed or delivered treatment, from type of illness, severity of the health problem, area of the country, the specific healthcare provider, and other factors. Indeed, different healthcare providers will prescribe various types and levels of treatment for the same or similar health problem at varying rates. Some reasons for the differing types and levels of treatment of a single health problem may include personal traits such healthcare provider preference, training, ideology, and knowledge about available treatments. External reasons may include treating relatively more severe presentations of the particular health problem than other providers. However, in some instances, certain healthcare providers may be prescribing and treating a particular health problem in excess relative to the manner in which other healthcare providers may treat a particular health problem. In other instances, poor or improper treatment of a health problem may require additional treatment. These excess and additional treatments are a source of waste in the healthcare system and contribute to increased overall costs for the system, which translate to higher payment costs for insurers and higher healthcare coverage of individuals.

### SUMMARY

In general, the invention relates to determining whether healthcare events are potentially preventable healthcare events. In some instances, healthcare providers prescribe treatment for a particular health problem in excess of other healthcare providers treating the same health problem. In other instances, health care providers provide inadequate or improper treatment, requiring additional treatment to not only treat the original health problem, but also possibly remedy any additional damage from the inadequate or improper treatment. Since some or all of these potentially preventable events are unnecessary, they represent an unnecessary cost for healthcare payers. Accordingly, by determining whether a healthcare event is a potentially preventable healthcare event, a healthcare payer may determine high-performing and under-performing healthcare providers and adjust payment to the healthcare providers based on a determined number or percentage of potentially preventable healthcare events. Healthcare providers may change standard practices or institute training programs to reduce the amount of potentially preventable healthcare events under the control of the specific healthcare provider.

In one embodiment, the invention is directed to a method of processing patient healthcare data, via one or more computers, the method comprising: receiving, at the one or more computers, patient healthcare data, wherein the patient healthcare data represents a healthcare event and includes one or more healthcare codes, determining, by the one or more computers and based on the one or more healthcare codes, one or more patient factors associated with the healthcare event, and determining, by the one or more computers and based on the one or more healthcare codes and the one or more patient factors associated with the healthcare event, whether the healthcare event is a potentially preventable healthcare event, wherein the healthcare event comprises one of: an inpatient admission, an emergency room visit, and an outpatient ancillary service.

In another embodiment, the invention is directed to a computerized healthcare system for processing healthcare data, the system comprising a computer that includes a processor and a memory, wherein the processor is configured to: receive patient healthcare data, wherein the patient healthcare data represents a healthcare event and includes one or more healthcare codes, determine, based on the one or more healthcare codes, one or more patient factors associated with the healthcare event, and determine, based on the one or more healthcare codes and the one or more patient factors associated with the healthcare event, whether the healthcare event is a potentially preventable healthcare event, wherein the healthcare event comprises one of: an inpatient admission, an emergency room visit, and an outpatient ancillary service.

In another embodiment, the invention is directed to a device for processing healthcare data, the device comprising: means for receiving patient healthcare data, wherein the patient healthcare data represents a healthcare event and includes one or more healthcare codes, means for determining, based on the one or more healthcare codes, one or more patient factors associated with the healthcare event, and means for determining, based on the one or more healthcare codes and the one or more patient factors associated with the healthcare event, whether the healthcare event is a potentially preventable healthcare event, wherein the healthcare event comprises one of: an inpatient admission, an emergency room visit, and an outpatient ancillary service.

In another embodiment, the invention is directed to a computer-readable medium containing instructions. The instructions cause a programmable processor to receive patient healthcare data, wherein the patient healthcare data represents a healthcare event and includes one or more healthcare codes, determine, based on the one or more healthcare codes, one or more patient factors associated with the healthcare event, and determine, based on the one or more healthcare codes and the one or more patient factors associated with the healthcare event, whether the healthcare event is a potentially preventable healthcare event, wherein the healthcare event comprises one of: an inpatient admission, an emergency room visit, and an outpatient ancillary service.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an example of a stand alone computer system for determining healthcare service episodes consistent with this disclosure.

FIG. 2 is another block diagram illustrating an example of a stand alone computer system for determining healthcare service episodes consistent with this disclosure.

FIG. 3 is a block diagram illustrating an example of a distributed system for determining patient episodes consistent with this disclosure.

FIG. 4 is a flow diagram illustrating a technique of this disclosure.

FIG. 5 is a flow diagram illustrating a technique of this disclosure.

FIG. 6 is a flow diagram illustrating a technique of this disclosure.

FIG. 7 is a flow diagram illustrating a technique of this disclosure.

### DETAILED DESCRIPTION

This disclosure describes systems and techniques for determining whether a healthcare event is a potentially preventable healthcare event. The systems and techniques may be used by a healthcare payer, such as a healthcare insurance company or Medicare and Medicaid, to establish or adjust reimbursement rates or payments to healthcare service providers based on the determined potentially preventable healthcare events. In other instances, the systems and techniques may be used by healthcare providers to track internal statistics surrounding potentially preventable healthcare events. In some instances, healthcare providers may implement internal procedures aimed at reducing the number of potentially preventable healthcare events.

Currently, healthcare providers may treat patients presenting with similar health problems differently. For example, some healthcare providers may prescribe relatively more or increased intensity diagnostic tests. Others may prescribe relatively more expensive treatment as an initial attempt to treat the problem than other healthcare providers. In some instances, healthcare providers may initially prescribe inefficient treatment which subsequently requires additional treatment. These differing rates of scheduled diagnostic tests, initially prescribing relatively more expensive treatment, and prescribing inefficient treatment leading to additional treatment, among others, all add to waste in the healthcare system. Determining these differing rates may assist in influencing healthcare provider practices, whether through educational programs or monetary penalties can help to reduce this waste and lower the total overall cost of the healthcare system.

The presently described system and techniques classify individual healthcare events into either potentially preventable or not-potentially preventable. Potentially preventable healthcare events are those events which may represent excessive healthcare services, i.e. waste. In particular, the system and techniques may identify relative rates of potentially preventable events across various healthcare providers. Each healthcare provider will have a residual rate of these determined potentially preventable healthcare events (e.g., a percentage of potentially preventable healthcare events to total healthcare events). That is, no healthcare provider will be able to completely eliminate each and every potentially preventable healthcare event. However, differences between the rates of potentially preventable healthcare events at individual healthcare providers can shed light on how well each particular healthcare provider compares to other healthcare providers. For example, a healthcare provider with a lower rate of potentially preventable healthcare events may be considered to be performing better than a healthcare provider with a higher rate of potentially preventable healthcare events. In other words, the first healthcare provider may be introducing relatively less “waste” into the system. In some instances, payers may wish to incentivize healthcare providers to reduce their rate of potentially preventable healthcare events by adjusting payments to providers based on this rate. Conversely, the healthcare providers may wish to determine and track their rate of potentially preventable healthcare events in order to implement internal procedures to reduce the rate.

As described in greater detail below, the methods of this disclosure may be performed by one or more computers. The methods may be performed by a stand alone computer, or may be executed in a client-server environment in which a user views the determined potentially preventable healthcare events at a client computer. In the later case, the client computer may communicate with a server computer. The server computer may store the patient healthcare data and apply the techniques of this disclosure to determine potentially preventable healthcare events and output the results to the client computer.

In one example, a method includes receiving, at the one or more computers, patient healthcare data, wherein the patient healthcare data represents a healthcare event and includes one or more healthcare codes. The method may further include determining, by the one or more computers and based on the one or more healthcare codes, one or more patient factors associated with the healthcare event. After determining the one or more patient factors, the method may determine, by the one or more computers and based on the one or more healthcare codes and the one or more patient factors associated with the healthcare event, a determination of whether the healthcare event is a potentially preventable healthcare event. In some examples, the healthcare event may comprise one of an inpatient admission, an emergency room visit, and an outpatient ancillary service.

Throughout the description of the techniques and systems of the present disclosure, the description describes the techniques and systems as determining whether a healthcare event is a potentially preventable healthcare event. In the context of this description, the term potentially healthcare event means a healthcare event is associated with one or more healthcare codes or determined patient factors that are consistent with a potentially preventable event. In other words, the techniques and systems described herein may not determine that an individual healthcare event could have been prevented, but rather the system and techniques may determine one or more healthcare events that are consistent with factors (such as predetermined healthcare codes and determined patient factors) indicating that the healthcare event could have been prevented. Accordingly, in some instances, not all of the identified potentially preventable healthcare events could have been prevented. However, knowing how many healthcare events are consistent with factors indicating that the healthcare event could have been prevented is still useful. For example, a relatively higher number of identified potentially preventable healthcare events may indicate a relatively higher number of actually preventable healthcare events. Even if this is not the case, a relatively higher number of determined potentially preventable healthcare events may be a sign to investigate the practices of providers associated with those identified potentially preventable healthcare events.

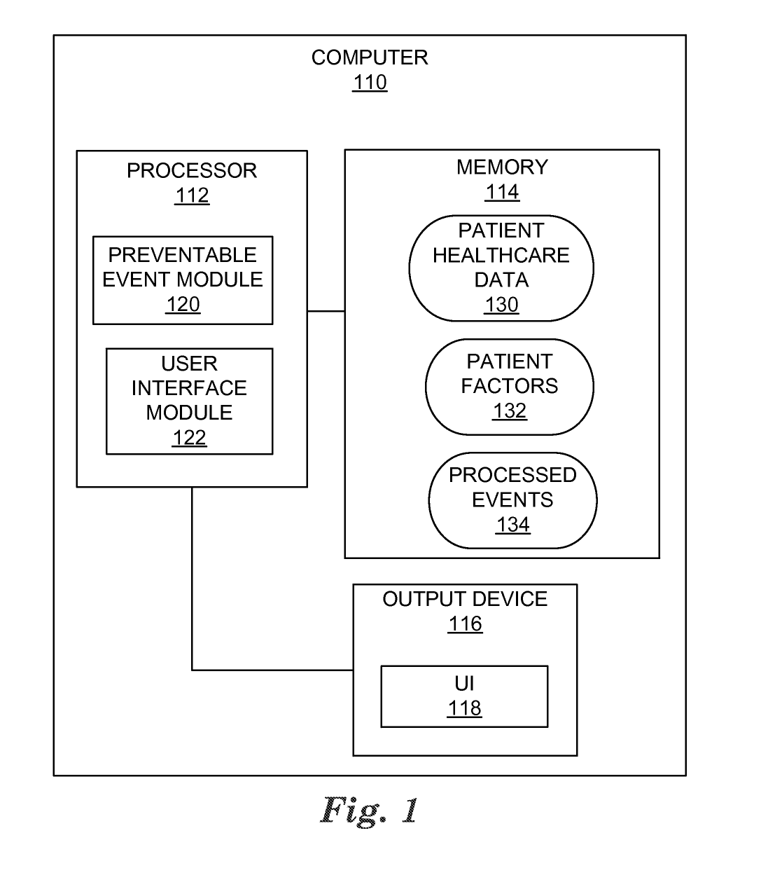

FIG. 1 is a block diagram illustrating an example of a stand-alone computerized system for determining potentially preventable healthcare events consistent with this disclosure. The system comprises computer 110 that includes a processor 112, a memory 114, and an output device 116. Computer 110 may also include many other components. The illustrated components are shown merely to explain various aspects of this disclosure.

Output device 116 may comprise a display screen, although this disclosure is not necessarily limited in this respect, and other types of output devices may also be used. Memory 114 includes patient healthcare data 130, which may comprise data collected in documents such as patient healthcare records, among other information. Memory 114 may further include patient factors 132 and processed events 134. Processor 112 is configured to include a user interface module 122 and a preventable event module 120 that executes techniques of this disclosure with respect to patient healthcare data 130 and, in some cases, patient factors 132. In some examples, processed events 134 may comprise information such as which healthcare events processor 112 and/or preventable event module 120 determined to be potentially preventable healthcare events. Also in some examples, patient factors 132 may store various associations, as described below, between one or more healthcare codes.

Processor 112 may comprise a general-purpose microprocessor, a specially designed processor, an application specific integrated circuit (ASIC), a field programmable gate array (FPGA), a collection of discrete logic, or any type of processing device capable of executing the techniques described herein. In one example, memory 114 may store program instructions (e.g., software instructions) that are executed by processor 112 to carry out the techniques described herein. In other examples, the techniques may be executed by specifically programmed circuitry of processor 112. In these or other ways, processor 112 may be configured to execute the techniques described herein.

Output device 116 may comprise a display screen, and may also include other types of output capabilities. In some cases, output device 116 may generally represent both a display screen and a printer in some cases. Preventable event module 120, and in some cases in conjunction with user interface module 122, may be configured to cause output device 116 to output patient healthcare data 130, patient factors 132, processed events 134, or other data. In some instances, output device 116 may include a user interface (UI) 118. UI 118 may comprise an easily readable interface for displaying the output information.

In one example, preventable event module 120 receives patient healthcare data 130. Generally, patient healthcare data 130 may include information included in a patient healthcare record or any other documents or files describing patient healthcare events. For example, when a patient has an encounter with a healthcare facility, such as during an inpatient admission, an emergency room visit, or an outpatient visit, all of the information gathered during the encounter and preceding the encounter may be consolidated into a patient healthcare record describing the particular healthcare event. In one example, such a patient healthcare record may include any procedures performed, any medications prescribed, any notes written by a physician or nurse, and generally any other information concerning the healthcare event. Additionally, the information may include the location of residence of the patient. For example, the location of residence may indicate whether the patient currently resides in a private home or in a managed home, such as a nursing home or other permanent or semi-permanent medical facility.

Patient healthcare data 130 may further include information from healthcare claims forms. These claims forms, or other documents in the patient medical record, may include one or more standard healthcare codes, as described in more detail below. The documents referred to herein are not limited to paper documents physically placed in a folder or other record keeping device. Increasingly, medical records are stored electronically. Accordingly, patient healthcare data 130 may be paper records fed into computer 110, or computer 110 may receive patient healthcare data electronically. Additionally, each piece of information included in patient data 130 may further be associated with a particular date. For example, patient healthcare data 130 may include multiple pieces of information associated with an inpatient admission event occurring on Mar. 20, 2005. In such an example, each piece of information related to that inpatient admission event may further be associated with the date Mar. 20, 2005 (or other relevant date if all the services or procedures relating to the inpatient admission did not occur on that exact date). In total, patient healthcare data 130 may comprise a complete or partial medical history. For example, all of the healthcare events for a given patient may be placed in order by date, thereby giving an overview of the chronological healthcare events that have occurred for a given patient.

Patient healthcare data 130 may further include one or more standard healthcare codes. In some examples, the patient healthcare records or the healthcare claims forms may include one or more of these standard healthcare codes, which generally may describe the services and procedures delivered to a patient. Examples of such healthcare codes include codes associated with the International Classification of Diseases (ICD) codes, Current Procedural Technology (CPT) codes, Healthcare Common Procedural Coding System codes (HCPCS), and National Drug Codes (NDCs). Each of these standard healthcare codes undergoes modification every few years, and the techniques and system of the present description contemplate using any such version of each of the above described codes. Other standard healthcare codes that may be included in patient healthcare data 118 may include Diagnostic Related Group (DRG) codes and Enhanced Ambulatory Patient Group (EAPG) codes. In some examples, these DRG and EAPG codes may be determined from the other standard healthcare codes. Additionally, these DRG and EAPG codes may represent a specific category of disease or health problem the patient suffers from or has suffered from in the past.

Preventable event module 120 may further determine one or more patient factors based on patient healthcare data 130. Some examples of patient factors a location of residence, the type of healthcare event, the sequence of events, and the clinical necessity for service.

In some examples, preventable event module 120 may determine the stage and severity of any diseases or other health problems based on patient healthcare data 130. For example, preventable event module 120 may use the one or more associated healthcare codes to determine the existence and severity of any disease or other health problem from which the patient suffers at the time of a healthcare event. These diseases and health problems may generally be referred to as comorbid diseases. For example, preventable event module 120 may determine, based on one or more received healthcare codes associated with dates prior to the current event. In other words, preventable event module 120 may receive historical patient medical data, and from that data determine the stage and extent of any comorbid diseases. In some examples, the healthcare codes directly indicate the existence of any disease or other health problem and the severity level. In other examples, patient healthcare data 130 determines the existence of any disease or other health problem and severity level based on the treatment directly indicated by the one or more healthcare codes.

In at least one example, preventable event module 120 processes the healthcare data to determine the existence and severity of any comorbid diseases in accordance with the techniques disclosed in U.S. Pat. No. 7,127,407 to Averill et al., the entirety of which is incorporated herein by reference. For example, preventable event module 120 may categorize information included in patient healthcare data 130 into a multi-level categorical hierarchy.

In some examples, as described previously, patient healthcare data 130 may include standard healthcare codes, such as ICD codes, CPT codes, HCPCS codes, and the like. At least some of these particular healthcare codes may be associated with past healthcare events or medical encounters—i.e. healthcare events or encounters not currently being analyzed in terms of whether the current healthcare event is a potentially preventable healthcare event. Accordingly, preventable event module 120 may use this historical data to produce a snapshot of the stage and extent of any comorbid disease a patient suffers from in order to assist in determining whether the current healthcare event is a potentially preventable healthcare event. Based on the received healthcare data, preventable event module 120 may create one or more categories or partition the received healthcare codes into categories such as Major Disease Categories (MDCs) or other categories as described in U.S. Pat. No. 7,127,407 to Averill et al. Each major disease category may represent a particular comorbid disease from which a patient suffers. Preventable event module 120 may further assign a severity of illness (SoI) indicator representing a relative severity of illnesses associated with any identified diseases.

Based on this methodology as discussed in U.S. Pat. No. 7,127,407 to Averill et al, preventable event module 120 may ultimately assign the patient to a Clinical Risk Group (CRG) based on the one or more determined categories. In some examples, preventable event module 120 may further determine a single adjustment factor based on the CRG assignment and the SoI indicator. This adjustment value may indicate a relative risk level. For example, the adjustment value may indicate that a patient represents a relatively more complex patient to treat than other, similarly situated patients. As an example, two patients, designated A and B, may visit the Emergency Department (ED) of a hospital for a broken arm. Patient A may be a 22 year-old suffering from pneumonia with no other history of ongoing illness. Patient B may be a 28 year-old who also suffers from pneumonia, but also suffers from cystic fibrosis. Both patients may fall into the same healthcare event type (i.e. and ED healthcare event), but Patient B represents a relatively more complex case to treat than does Patient A.

In some examples, preventable event module 120 may determine a CRG window. The CRG window may define a period of time surrounding a particular healthcare event. This CRG window may be the time period over which preventable event module 120 looks to determine a patient's CRG (such as by the method described in U.S. Pat. No. 7,127,407 to Averill et al). For example, preventable event module 120 may include data in determining a CRG that is associated with dates that fall within the CRG window. In some examples, the CRG window may comprise a period of time before a healthcare event. According to at least some examples, preventable event module 120 may determine a CRG window based on received user input. For example, user input may indicate a specific date, where the CRG window encompasses the time period before the specified date. Preventable event module 120 may further determine the CRG assignment and SoI indicator based on the patient healthcare data 130 that is associated with dates that fall within the CRG window.

As discussed previously, preventable event module 120 may also determine a location of residence associated with a particular healthcare event. This parameter may indicate whether a patient was residing at a private residence or a semi- or full-service medical facility at the time of the healthcare event. Such facilities may include nursing homes, skilled nursing facilities, certain psychological centers, and other facilities that administer and care for groups of people, but do not rise to the level of outpatient service facilities. In some examples, patient healthcare data 130 may include one or more healthcare codes that directly indicate a location of residence. In other examples, preventable event module 120 may determine the location of residence based on information included in patient healthcare data 130. For example, patient healthcare data 130 may include health care codes associated with treatment at a semi- or full-service medical facility. In such examples, preventable event module 120 may determine the location of residence to be a semi- or full-service medical facility based on the presence of the one or more codes and if the codes are associated with dates occurring in the last 1 day, 3 days, 7 days, or other time period lengths.

In addition to determining the presence and severity of comorbid diseases and a location of residence, preventable event module 120 may also determine a type of healthcare event for each healthcare event. As described previously, each healthcare event may comprise either an inpatient event, an emergency department (ED) event, or an ancillary service event. In some examples, preventable event module 120 determines the type of event based on the healthcare codes associated with the particular healthcare event. For example, each of the healthcare codes may be associated with a type of healthcare event, and, based on the healthcare codes and their associations, preventable event module 120 may determine that an event is one of an inpatient event, an emergency department event, or an ancillary service event. In other examples, a specific healthcare code may directly signal whether an event is an inpatient event, an emergency department event, or an ancillary service event.

In some examples, preventable event module 120 may additionally determine a sequence of services factor. For example, preventable event module 120 may determine a window time period surrounding a specific healthcare event. In some instances, the window comprises only a time period occurring prior to a current healthcare event. Within this window, preventable event module 120 may determine other healthcare events. These other healthcare events that occur during the windowed period may comprise context for a current healthcare event. That is, in determining whether a current event is a potentially preventable healthcare event, preventable event module 120 may determine whether a current healthcare event is a potentially preventable healthcare event based at least in part on these determined contextual healthcare events. In some examples, the presence or absence of a particular healthcare event (or particular healthcare codes or diagnoses) in the past may indicate that a current healthcare event is a potentially preventable event. Patient factors 132 may contain such associations between the various healthcare codes. In other words, patient factors 132 may contain associations indicating that the presence of a first healthcare code in a current healthcare event indicate that the current healthcare event is a potentially preventable healthcare event if a second healthcare code is not present in patient healthcare data 130 associated with a date prior to the current healthcare event.

As an illustration, suppose that a patient was diagnosed with an endocardial cushion defect. Eleven months after diagnosis was established, the patient underwent echocardiography. In this instance, preventable event module 120 may determine that the context of the healthcare event surrounding the endocardial cushion defect made it likely that echocardiography was to be necessary for this patient. Accordingly, preventable event module 120 may determine that the healthcare event surrounding the echocardiography was not a potentially preventable healthcare event. In contrast, preventable event module 120 may determine that a healthcare event including echocardiography without a first diagnosis of an endocardial cushion defect, or the like, is a potentially preventable healthcare event because there are no additional context healthcare events indicating that the echocardiography was likely to be necessary.

In yet other examples, preventable event module 120 may determine the clinical necessity for service. For example, patient factors 132 may contain a listing of healthcare codes that correspond to a low clinical necessity. Preventable event module 120 may receive use these associations to determine whether a clinical necessity factor indicates that a healthcare event is a potentially preventable healthcare event. In other words, if one or more healthcare codes associated with a current healthcare event correspond to healthcare codes indicating a low clinical necessity based on the associations stored in patient factors 132, preventable event module 120 determines that the clinical necessity factor for the current healthcare event indicates that the current healthcare event is a potentially preventable healthcare event. One example of a service with a low clinical necessity for service is an MRI for low back pain.

After determining one or more of patient factors, preventable event module 120 may then determine whether a current healthcare event is a potentially preventable healthcare event based on the one or more healthcare codes and determined patient factors associated with the current healthcare event. As alluded to above, each of patient factors may indicate either that a current healthcare event is a potentially preventable healthcare event or that the current healthcare event is not a potentially preventable healthcare event. That is, for a first healthcare event, each patient factor may indicate that the particular first event is or is not a potentially preventable healthcare event. For a second healthcare event, each patient factor may indicate differently whether the second healthcare event is or is not a potentially preventable healthcare event.

In other examples, memory 114 may store a list of healthcare codes that have been predetermined to be potentially preventable healthcare events. Accordingly, preventable event module 120 may make an initial determination that a healthcare event is a potentially preventable healthcare event based on the presence of one or more of the codes stored in memory 114. In such examples, each of the determined patient factors may indicate that the initially determined potentially preventable healthcare event is actually not a potentially preventable healthcare event. Accordingly, preventable event module 120 may make a final determination of whether a healthcare event is a potentially preventable healthcare event based additionally on the determined patient factors 132. In other examples, preventable event module 120 may make an initial determination that a healthcare event is not a potentially preventable healthcare event based on the absence of one or more healthcare codes associated with predetermined potentially preventable healthcare events. In such examples, one or more of the determined patient factors may then indicate that a potentially non-preventable healthcare event is actually a potentially preventable healthcare event. Accordingly, preventable event module 120 may make a final determination of whether the healthcare event is a potentially preventable healthcare event based additionally on the determined patient factors. A number of examples are set out below illustrate how the various determined patient factors may influence the determination of whether a current healthcare event is a potentially preventable healthcare event. In at least some examples, the stage and extent of comorbid diseases always indicates that a healthcare event is not a potentially preventable healthcare event and the physical site of residency, sequence of services, and clinical necessity for services always indicate whether a healthcare event is a potentially preventable healthcare event.

As one example, suppose that a 73 year old female was admitted to a hospital for a head trauma. Her signs and symptoms include head pain, dizziness, and short term memory loss. X-rays showed no fracture, but possible brain bleeding. While the patient was in the hospital, the patient was monitored overnight and received pain medication, in addition to IV fluids. She was released after 24 hours of monitoring continued on pain medication as needed. The patient did not have any other relevant healthcare events occurring over the last two years.

In the above described scenario, preventable event module 120 may determine that the healthcare event type is an inpatient admission type. Preventable event module 120 may further initially determine that, based on the one or more healthcare codes associated with the inpatient admission event, that the inpatient admission is not a potentially preventable healthcare event. For example, this is the case when none of the healthcare codes associated with the inpatient admission match any of the predetermined codes that indicate a healthcare event is a potentially preventable healthcare event.

Additionally, based on the one or more healthcare codes or other information in patient healthcare data 130, preventable event module 120 may determine that the patient was not residing at a semi- or full-service medical facility at the time of the inpatient admission. In this instance, preventable event module 120 already initially determined that the inpatient admission event is not a potentially preventable healthcare event. Since the patient was not residing at a semi- or full-service medical facility, preventable event module 120 does not determine that the location of residence patient factor indicates that the event should be a potentially preventable healthcare event.

Preventable event module 120 may also determine that the patient did not have any other comorbid diseases at the time of admission for the head trauma. This determination may be based on the lack of healthcare events occurring within the a predetermined time period prior to the current healthcare event (such as 6 months, 1 year, 3 years, or any other period of time), or other information contained in the medical record. As discussed above, this factor may only indicate that a potentially preventable healthcare event should in actuality be determined to be not a potentially preventable healthcare event. Since, in this instance, the initial determination is that the inpatient admission event is not a potentially preventable event, this factor will not change that determination.

Further, based on a list of healthcare codes indicating a low clinical necessity, preventable event module 120 may determine that none of the healthcare codes associated with the current healthcare event corresponds to those low clinical necessity codes. For example, the healthcare codes associated with pain medications and head x-rays may not be associated with services associated with low clinical necessity. Accordingly, preventable event module 120 may determine that the clinical necessity factor does not indicate that the current healthcare event is a potentially preventable healthcare event.

Finally, preventable event module 120 may determine that the sequence of services factor also does not indicate that the inpatient event is a potentially preventable healthcare event. For example, preventable event module 120 may determine that none of the healthcare codes associated with the inpatient admission event requires the presence or absence of healthcare codes or diagnoses prior to the current healthcare event. In other words, preventable event module 120 may determine that the sequence of services factor does not indicate that the current event is a potentially preventable healthcare event because none of the healthcare codes associated with the current healthcare event require the presence or absence of healthcare codes or diagnoses in the past in order for preventable event module 120 to determine that the sequence of services factor indicates that the current healthcare event is not a potentially preventable healthcare event.

Accordingly, for the above example, preventable event module 120 may ultimately determine that the inpatient admission event is not a potentially preventable healthcare event.

As another example, assume a similar patient was admitted for head trauma. Except, in this example, preventable event module 120 determines that the location of residence patient factor is a nursing home instead of a private residence.

In this example, as in the other example, none of the stage and extent of comorbid disease, sequence of services, and clinical necessity of services patient factors indicate that the inpatient admission event should be a potentially preventable healthcare event. However, in this case, the location of residence patient factor does indicate that the inpatient admission event should be a potentially preventable healthcare event. For example, at the time of the trauma, the patient was under the care of a semi- or full-service medical facility. If the facility had taken proper precautions and care of the patient, the trauma should not have occurred. Accordingly, preventable event module 120 may determine that the location of residence patient factor indicates that the inpatient admission event is potentially preventable healthcare event and may make a final determination that the event is a potentially preventable healthcare event.

As another example, suppose that an 89 year old male who has a medical history of asthma was admitted to the hospital with complaints of shortness of breath and tightness in the chest. The patient was treated with medication and discharged from the hospital after two days. The location of residence prior to the inpatient admission event was a private residence.

In the above described scenario, preventable event module 120 may determine that the healthcare event type is an inpatient admission type. Preventable event module 120 may further initially determine that, based on the one or more healthcare codes associated with the inpatient admission event, that the inpatient admission is a potentially preventable healthcare event. For example, this is the case when one or more of the healthcare codes associated with the inpatient admission match any of the predetermined codes that indicate a healthcare event is a potentially preventable healthcare event. In this case, with proper medication and on-going care for the asthma, this inpatient admission should be preventable.

Additionally, based on the one or more healthcare codes or other information in patient healthcare data 130, preventable event module 120 may determine that the patient was not residing at a semi- or full-service medical facility at the time of the inpatient admission. In this instance, preventable event module 120 already initially determined that the inpatient admission event is a potentially preventable healthcare event. As the location of residence patient factor may not indicate that an event should not be a potentially preventable healthcare event, this particular factor does not apply.

Preventable event module 120 may also determine that the patient did not have one or more comorbid diseases at the time of admission for the shortness of breath and tightness in chest. This determination may be based on the lack of healthcare events occurring within the a predetermined time period prior to the current healthcare event (such as 6 months, 1 year, 3 years, or any other period of time), or other information contained in the medical record. In this instance, there are no other factors indicating that, with proper care and management of the patient's asthma, that this inpatient admission event would not have been preventable.

Further, based on a list of healthcare codes indicating a low clinical necessity, preventable event module 120 may determine that none of the healthcare codes associated with the current healthcare event corresponds to those low clinical necessity codes. In this example, since preventable event module 120 already initially determined that the inpatient admission event is a potentially preventable healthcare event, this patient factor does not apply—this factor only indicates that a particular healthcare event should be a potentially preventable healthcare event and does not indicate that a potentially preventable healthcare event should actually not be a potentially preventable healthcare event.

Finally, preventable event module 120 may also determine that the sequence of services factor does not apply. For example, the sequence of services factor may determine that a healthcare event may be a potentially preventable healthcare event. In this example preventable event module 120 has already determined that the inpatient admission event is a potentially preventable healthcare event.

The above examples were discussed with respect to inpatient admission type healthcare events. As discussed previously, the healthcare events may be grouped into other healthcare event types, such as ancillary service events and emergency department events. The below examples describe determining whether a healthcare event is a potentially preventable healthcare event with regard to these other healthcare event types.

As one example, imagine a 45 year old patient underwent a gum graft due to tooth sensitivity. The patient's medical record does not indicate any other relevant healthcare events in the recent past. Further, the medical record indicates that the location of residence was a private residence at the time of the procedure.

In the above described scenario, preventable event module 120 may determine that the healthcare event type is an ancillary service event type. Preventable event module 120 may further initially determine that, based on the one or more healthcare codes associated with the inpatient admission event, that the ancillary service event is not a potentially preventable healthcare event.

Additionally, based on the one or more healthcare codes or other information in patient healthcare data 130, preventable event module 120 may determine that the patient was not residing at a semi- or full-service medical facility at the time of the inpatient admission. In this instance, preventable event module 120 already initially determined that the inpatient admission event is not a potentially preventable healthcare event. Since the patient was not residing at a semi- or full-service medical facility, preventable event module 120 does not determine that the location of residence patient factor indicates that the event should be a potentially preventable healthcare event.

Preventable event module 120 may also determine that the patient did not have any other comorbid diseases at the time of treatment for the gum graft. This determination may be based on the lack of healthcare events occurring within a predetermined time period prior to the current healthcare event. As discussed above, this factor may only indicate that a potentially preventable healthcare event should in actuality be determined to be not a potentially preventable healthcare event. Since, in this instance, the initial determination is that the ancillary service event is not a potentially preventable event, this factor will not change that determination.

Further, based on a list of healthcare codes indicating a low clinical necessity, preventable event module 120 may determine that none of the healthcare codes associated with the current healthcare event corresponds to those low clinical necessity codes. For example, the healthcare codes associated with the gum graft procedure may not be associated with services associated with low clinical necessity. Accordingly, preventable event module 120 may determine that the clinical necessity factor does not indicate that the current healthcare event is a potentially preventable healthcare event.

Finally, preventable event module 120 may determine that the sequence of services factor also does not indicate that the ancillary service event is a potentially preventable healthcare event. For example, preventable event module 120 may determine that none of the healthcare codes associated with the ancillary service event requires the presence or absence of healthcare codes or diagnoses prior to the current healthcare event. In other words, preventable event module 120 may determine that the sequence of services factor does not indicate that the current event is a potentially preventable healthcare event because none of the healthcare codes associated with the current healthcare event require the presence or absence of healthcare codes or diagnoses in the past in order for preventable event module 120 to determine that the sequence of services factor indicates that the current healthcare event is not a potentially preventable healthcare event.

Accordingly, for the above example, preventable event module 120 may ultimately determine that the ancillary service event is not a potentially preventable healthcare event.

As another example, imagine that a 35 year-old male went to his primary care physician complaining of lower back pain. The physician ordered an MRI for the patient's back. The patient was currently residing in a private residence and had no other relevant healthcare events in the recent past.

As before, preventable event module 120 may determine that the location of residence is a private residence. Additionally, preventable event module 120 may also determine that the healthcare event is an ancillary service event and make an initial determination that the ancillary service event is not a potentially preventable healthcare event. For example, this is the case when one or more of the healthcare codes associated with the inpatient admission do not match any of the predetermined codes that indicate a healthcare event is a potentially preventable healthcare event.

Similar to the previous example, preventable event module 120 may determine that the stage and extent of comorbid disease patient factor, the location of residence patient factor, and the sequence of services patient factor all either do not indicate that the ancillary service event should be a potentially preventable healthcare event or are not applicable (for example, because they indicate whether a potentially preventable healthcare event is not a potentially preventable healthcare event and because preventable event module 120 already made an initial determination that the ancillary service event is not potentially preventable healthcare event).

However, in this case, the clinical necessity of services patient factor does indicate that the ancillary service event should be a potentially preventable healthcare event. For example, the healthcare codes indicating an MRI test, in the context of a diagnosis of lower back pain may be on the list of low clinical necessity services. Accordingly, preventable event module 120 may determine that the clinical necessity of services indicates that the ancillary service event should be a potentially preventable healthcare event based on the presence of one or more healthcare codes associated with the list of low clinically necessary services.

Accordingly, for the above example, preventable event module 120 may ultimately determine that the ancillary service event is a potentially preventable healthcare event.

As another example, imagine that a patient went to the ED with fever, weakness, and red, painful lumps. The patient was diagnosed at the ED with necrotizing fasciitis. The patient was treated with antibiotic medication. Additionally, the medical record indicates that the location of residence was a nursing home.

In the above described scenario, preventable event module 120 may determine that the healthcare event type is an emergency department (ED) type event. Preventable event module 120 may further initially determine that, based on the one or more healthcare codes associated with the inpatient admission event, that the ancillary service event is not a potentially preventable healthcare event.

Additionally, based on the one or more healthcare codes or other information in patient healthcare data 130, preventable event module 120 may determine that the patient was residing at a semi- or full-service medical facility at the time of the inpatient admission (in this instance, in a nursing home). In this instance, preventable event module 120 already initially determined that the inpatient admission event is not a potentially preventable healthcare event. Since the patient was residing at a semi- or full-service medical facility, preventable event module 120 does determine that the location of residence patient factor indicates that the event should be a potentially preventable healthcare event. In this instance, under proper care, the infection would not have happened, or that it would have been dealt with prior to needing to an ED visit.

Preventable event module 120 may also determine that the patient did not have any other comorbid diseases at the time of treatment for the infection. This determination may be based on the lack of healthcare events occurring within a predetermined time period prior to the current healthcare event. As discussed above, this factor may only indicate that a potentially preventable healthcare event should in actuality be determined to be not a potentially preventable healthcare event. Since, in this instance, the initial determination is that the ancillary service event is not a potentially preventable event, this factor will not change that determination.

Further, based on a list of healthcare codes indicating a low clinical necessity, preventable event module 120 may determine that none of the healthcare codes associated with the current healthcare event corresponds to those low clinical necessity codes. For example, the healthcare codes associated with the antibiotics for the infection may not be associated with services associated with low clinical necessity. Accordingly, preventable event module 120 may determine that the clinical necessity factor does not indicate that the current healthcare event is a potentially preventable healthcare event.

Finally, preventable event module 120 may determine that the sequence of services factor also does not indicate that the ancillary service event is a potentially preventable healthcare event. For example, preventable event module 120 may determine that none of the healthcare codes associated with the ED event requires the presence or absence of healthcare codes or diagnoses prior to the current healthcare event. In other words, preventable event module 120 may determine that the sequence of services factor does not indicate that the current event is a potentially preventable healthcare event because none of the healthcare codes associated with the current healthcare event require the presence or absence of healthcare codes or diagnoses in the past in order for preventable event module 120 to determine that the sequence of services factor indicates that the current healthcare event is not a potentially preventable healthcare event.

Accordingly, for the above example, preventable event module 120 may ultimately determine that the ED event is a potentially preventable healthcare event.

Note that in the above situation, if the patient had a location of residence of a private residence, preventable event module 120 would have determined that the location of residence patient factor indicates that the ED event was not a potentially preventable healthcare event. In this circumstance, preventable event module 120 would determine that the ED event was not a potentially preventable healthcare event.

In some examples, additional factors may apply to one or more of the various healthcare event types. For instance, for each healthcare event type, i.e. inpatient admission events, ancillary service events, and ED events, preventable event module 120 may determine a health status exclusion factor. In some examples this health status exclusion factor is combined with the stage and extent of any comorbid disease factor. For instance, if the stage and extent of any comorbid diseases indicate the presence of particular diseases or health problems, or that various diseases or health problems have reached a particular severity level, preventable event module 120 may determine that the healthcare event has an associated positive health status exclusion factor. In all examples that include determining a health status exclusion factor, preventable event module 120 determines whether the current healthcare event is excluded from a determination that the healthcare event is a potentially preventable healthcare event based on the health status of the patient. For example, as discussed above, preventable event module 120 may determine one or more DRG/EAPG/CRG and SoI parameters associated with each patient. In general, these parameters may indicate a type and severity of comorbid diseases from which the patient suffers. If the parameters indicate an excessively severe condition, preventable event module 120 determines a positive health status exclusion factor for the current healthcare event. Some examples of excessively severe conditions include metastatic cancers, malignant neoplasms, and severe hypertension, among other severe health conditions. If preventable event module 120 determines a positive health status exclusion factor, preventable event module 120 determines that the current healthcare event is a not potentially preventable healthcare event.

In some examples, preventable event module 120 determines whether a healthcare event is a potentially preventable healthcare event in a two-stage decision process. For example, preventable event module 120 may determine whether a healthcare event is a potentially preventable healthcare event similar to the process identified above, only that the determination is only an initial determination. In such examples, preventable event module 120 may then determine the presence of any positive health status exclusion factors. Based on this determination, preventable event module 120 makes a final determination of whether a healthcare event is a potentially preventable healthcare event. In instances where preventable event module 120 determines a positive health status exclusion factor, preventable event module 120 always makes a determination that the healthcare event is not a potentially preventable healthcare event. In examples where preventable event module 120 determines whether the healthcare event is a potentially preventable healthcare event in a single stage process, the presence of a positive health status exclusion factor overrides the other factors and preventable event module 120 determines that the healthcare event is not a potentially preventable healthcare event.

In the ED type healthcare event determinations, preventable event module 120 may determine another additional factor: a trauma factor. Trauma factors may indicate that, as opposed to a disease or other health problem, the patient suffered from a trauma, such as a broken bone or other damage resulting from an impact. In such examples, the trauma factor, in combination with a location of residence indicating residence at a semi- or full-service medical facility, may override determining that a healthcare event is not a potentially preventable healthcare event.

As an illustration the incorporation of a trauma factor in the determination process, imagine an 80 year old patient arriving at the ED from a nursing home with a fractured arm. The patient's medical record indicates that the location of residence was a nursing home and that the patient suffers from lung cancer.

In this example, preventable event module 120 may determine that the type of event is an ED event. Additionally, preventable event module 120 may initially determine, based on the one or more healthcare codes, that the ED event is not a potentially preventable healthcare event.

Preventable event module 120 may further determine that that the location of residence factor indicates resident at a semi- or full-service medical facility (in this case, a nursing home). In this instance, since preventable event module 120 initially determined that the ED event was not a potentially preventable healthcare event, the location of residence factor does indicate that the ED event is a potentially preventable healthcare event.

Additionally, since the type of injury is a trauma injury, preventable event module 120 may determine that the trauma patient factor is positive. That is, preventable event module 120 may determine that one or more of the healthcare codes are associated with a list of healthcare codes that indicates which particular healthcare codes correspond to a trauma injury. This list of healthcare codes that indicate trauma injury may be stored in memory 114 and/or patient factors 132.

The ancillary service event and clinical necessity of services patient factors either do not apply or only further indicate that the event is a potentially preventable healthcare event. For example, the clinical necessity of services also does not indicate that the ED event should be a potentially preventable healthcare event because nothing indicates that the treatment for the broken arm is associated with a list of healthcare codes associated with low clinical necessity. Further, the sequence of services patient factor also does not indicate that the ED event should be a potentially preventable healthcare event. For example, the healthcare codes associated with the ED event do not require the presence or absence of previous healthcare codes or diagnoses in order for the sequence of services patient factor to indicate that the healthcare event should not be a potentially preventable healthcare event.

However, preventable event module 120 may determine a positive health status exclusion patient factor for this patient. For example, the presence of lung cancer as a comorbid disease would indicate that preventable event module 120 would determine a positive health status exclusion.

However, for the above example, preventable event module 120 would ultimately determine that the ED event is a potentially preventable healthcare event. In this example, the trauma factor and the location of residence indicating residence at a nursing home override the positive health status exclusion factor. For example, the nursing home should have provided a safer environment such that the broken arm would have been preventable.

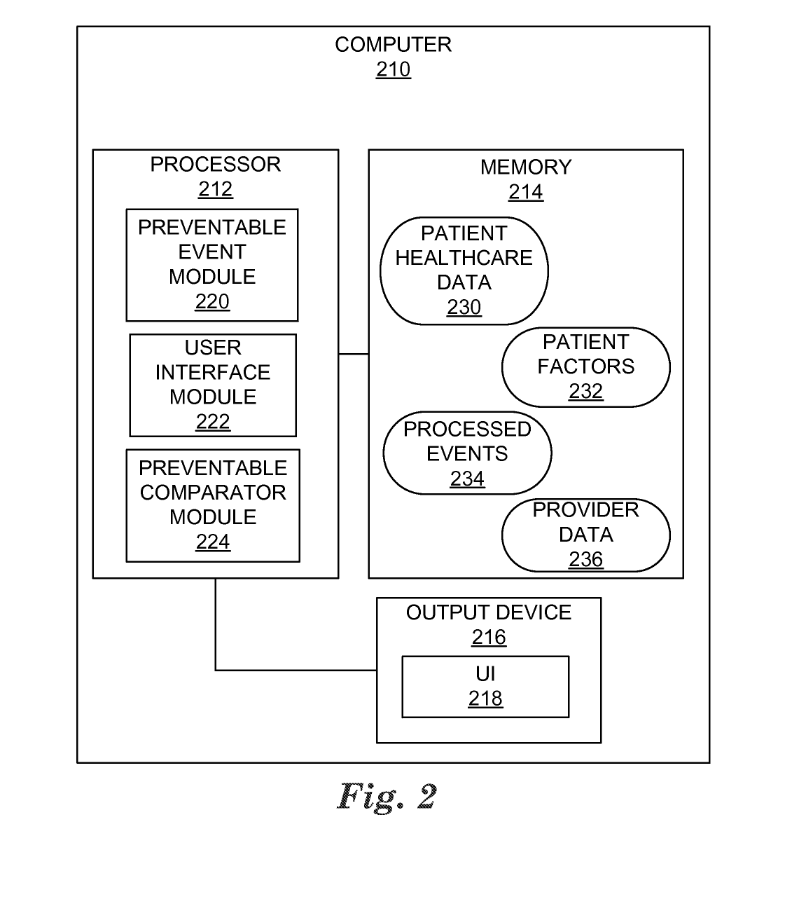

FIG. 2 describes another block diagram illustrating an example of a stand-alone computerized system for determining whether a healthcare event is a potentially preventable healthcare event. In general, components depicted in FIG. 2 with similar names to those components depicted in FIG. 1 operate in a similar manner. However, FIG. 2 contains additional components not depicted in FIG. 1. The following description will focus on these additional components.

For example, the system comprises computer 210 that includes a processor 212, a memory 214, and an output device 216. Computer 210 may also include many other components. The illustrated components are shown merely to explain various aspects of this disclosure.

Output device 216 may comprise a display screen, although this disclosure is not necessarily limited in this respect, and other types of output devices may also be used. Memory 214 stores patient healthcare data 230, which may comprise data such as that described with respect to patient healthcare data 130. Memory 214 may further store patient factors 232, processed events 234, and provider data 236.

Processor 212 is configured to include preventable event module 220 that executes techniques of this disclosure with respect to patient healthcare data 230 and patient factors 232. Processor 212 may be further configured to include a user interface module 222, and a preventable comparator module 224.

Processor 212 may comprise a general-purpose microprocessor, a specially designed processor, an application specific integrated circuit (ASIC), a field programmable gate array (FPGA), a collection of discrete logic, or any type of processing device capable of executing the techniques described herein. In one example, memory 214 may store program instructions (e.g., software instructions) that are executed by processor 212 to carry out the techniques described herein. In other examples, the techniques may be executed by specifically programmed circuitry of processor 212. In these or other ways, processor 212 may be configured to execute the techniques described herein. Further, the functionality of the specific modules depicted as included in processor 212 may be combined into fewer, or even a single module, without leaving the scope of this disclosure.

Output device 216 may comprise a display screen, and may also include other types of output capabilities. In some cases, output device 216 may generally represent both a display screen and a printer in some cases. Preventable event module 220, and communication interface module 222 in some examples, may be configured to cause output device 216 to output patient healthcare data 230, provider data 236, processed events 234, or other data. In some instances, output device 216 may include a user interface (UI) 218. UI 218 may comprise an easily readable interface for displaying the output information. Outputting patient healthcare data 230, provider data 236, processed events 234, or other data may assist payers in determining potentially preventable healthcare events and in adjusting a payment or payments based on the determined potentially preventable healthcare events.

As mentioned above, in general, the similarly-named modules depicted in FIG. 2 may perform similar functions to those similarly-named modules depicted in FIG. 1. For example, preventable event module 220 may determine potentially preventable healthcare events in a manner similar to that described in relation to preventable event module 120. However, the modules identified in FIG. 2 may have additional functions.

In some examples, preventable event module 220 may determine potentially preventable healthcare events based on patient healthcare data 230 and patient factors 232. In some examples, preventable event module 220 may determine potentially preventable healthcare events additionally based on provider data 236. In some examples, preventable event module 220 may determine potentially preventable healthcare events based on patient healthcare data 230, patient factors 232, and provider data 236 associated with a single patient. In other examples, preventable event module 220 may determine potentially preventable healthcare events based on patient healthcare data 230, patient factors 232, and provider data 236 associated with a plurality of patients. Further, preventable event module 220 may store these determined potentially preventable healthcare events associated with the one or more patients in memory 214 and processed events 234.

In at least one example, provider data 236 includes information identifying the health care provider that treated a patient for a specific healthcare event. For instance, provider data 236 may include the specific healthcare facility where the treatment took place, the specific physician or other healthcare professional that administered the treatment, other healthcare staff that assisted in treatment of the patient, or other individuals or organizations that assisted in treatment of the patient for a specific healthcare event. In this manner, preventable event module 220 may further determine one or more healthcare providers associated with each healthcare event. Preventable event module 220 may further store these associations in memory 214, processed events 234, and/or provider data 236. By providing these associations, the techniques and system described herein allows for a user to compile statistics associated with individual healthcare providers concerning their rates of potentially preventable healthcare events.

In some examples, after preventable event module 220 has processed the multiple healthcare events associated with a plurality of providers and stored the determinations in memory 214 and processed events 234, preventable comparator module 224 may determine one or more metrics. For example, preventable comparator module 224 may determine a total number of potentially preventable healthcare events associated with each specific healthcare provider. In other examples, preventable comparator module 224 may determine a percentage of potentially preventable healthcare events to total healthcare events for a specific healthcare provider. In at least one example, preventable comparator module 224 may determine rates of potentially preventable healthcare events of a particular type, i.e. inpatient admission event, ancillary service event, and ED event. In other examples, preventable comparator module 224 may determine rates of potentially preventable healthcare events for a particular disease. In still other examples, preventable comparator module 224 may compare the determined rates of potentially preventable healthcare events between multiple providers. In still other examples, preventable comparator module 224 may determine an average rate of potentially preventable healthcare events across all healthcare providers, or only selected healthcare providers, and may further determine differences from the average for each individual healthcare provider.

Comparing the rates, or the adjusted rates, of potentially preventable healthcare events across multiple providers provides a number of benefits. For example, healthcare payers, such as private health care insurers and Medicare and Medicaid, may use such comparisons to identify those healthcare providers that are relatively efficient and relatively inefficient with their use of medical resources. Additionally, the payers may adjust payment to the healthcare providers based on these rates. For example, the payers may adjust payments or payment rates lower, such as one, three, or five percent, as examples, for certain healthcare providers based on the high relative rates for those particular healthcare providers. Alternatively, the payers may increase payments or payment rates for those healthcare providers with relatively lower rates of potentially preventable healthcare events. Adjusting the payment may incentivize the healthcare providers to reduce their rates of potentially preventable healthcare events, thereby reducing excessive healthcare spending and lowering total payments by the healthcare payers. Additionally, healthcare providers may use the described system and techniques for internal purposes. For example, healthcare providers may determine their own rates of potentially preventable healthcare events and implement internal procedures in an attempt to reduce their rates of potentially preventable healthcare events.

In some examples, preventable event module 220 may associate the metrics with the determined patient CRGs. This association may allow for comparison across the various CRG groups. For example, preventable event module 220/preventable comparator module 224 may output the determined potentially preventable healthcare events or rates of potentially preventable healthcare events based on CRG group. The CRG groups generally denote relative levels of patient health status. Accordingly, the output events and rates may then be compared across relative similar levels of patient health. This type of association may be beneficial because the particular rates of potentially preventable healthcare events may be impacted by the relative level of health status of a particular provider's patient population.

The system of FIG. 1 is a stand-alone system in which processor 112 that executed preventable event module 120 and output device 116 that outputs various data reside on the same computer 110. However, the techniques of this disclosure may also be performed in a distributed system that includes a server computer and a client computer. In this case, the client computer may communicate with the server computer via a network. The preventable event module may reside on the server computer, but the output device may reside on the client computer. In this case, when the preventable event module causes display prompts, the preventable event module causes the output device of the client computer to display the data, e.g., via commands or instructions communicated based on the server computer to the client computer.

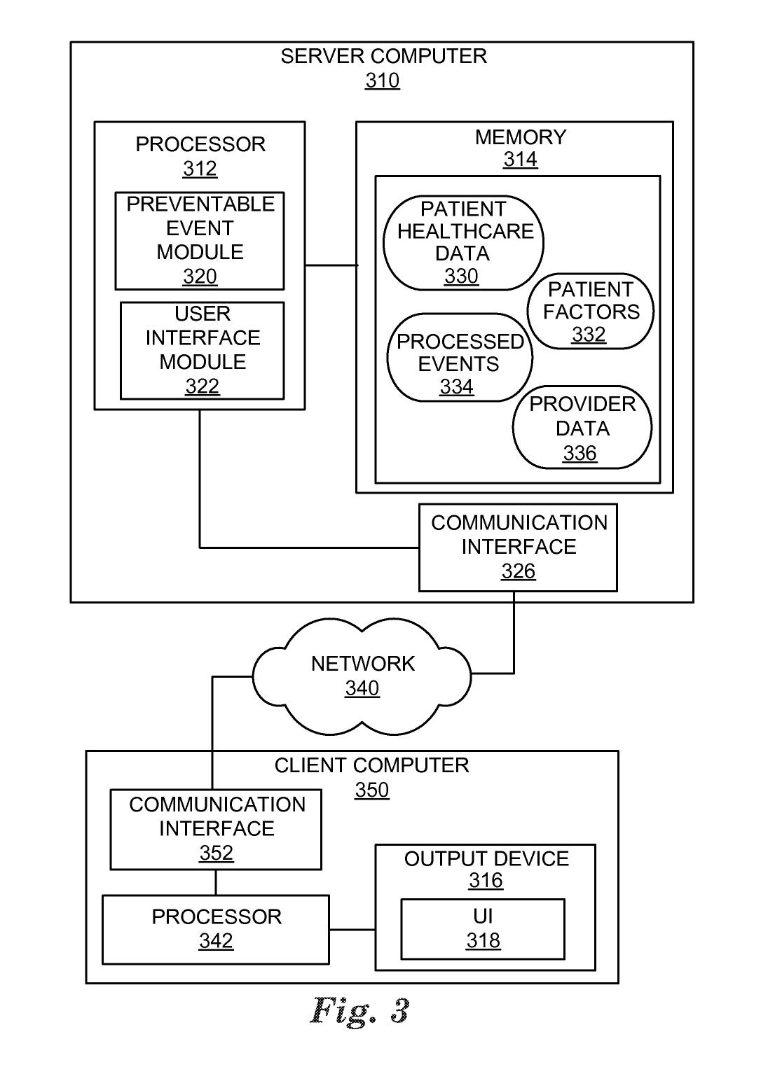

FIG. 3 is a block diagram of a distributed system that includes a server computer 310 and a client computer 350 that communicate via a network 340. In the example of FIG. 3, network 340 may comprise a proprietary on non-proprietary network for packet-based communication. In one example, network 340 comprises the Internet, in which case communication interfaces 326 and 352 may comprise interfaces for communicating data according to transmission control protocol/internet protocol (TCP/IP), user datagram protocol (UDP), or the like. More generally, however, network 340 may comprise any type of communication network, and may support wired communication, wireless communication, fiber optic communication, satellite communication, or any type of techniques for transferring data between a source (e.g., server computer 310) and a destination (e.g., client computer 340).

Server computer 310 may perform the techniques of this disclosure, but the user may interact with the system via client computer 350. Server computer 310 may include a processor 312, a memory 314, and a communication interface 326. Client computer 350 may include a communication interface 352, a processor 342 and an output device 316. Of course, client computer 350 and server computer 310 may include many other components. The illustrated components are shown merely to explain various aspects of this disclosure.

Output device 316 may comprise a display screen, although this disclosure is not necessarily limited in this respect and other output devices may also be used. Memory 314 stores patient healthcare data 330, which may comprise data collected in documents such as patient healthcare records, among other information. Memory 314 further stores patient factors 332, processed events 334, and provider data 336. Processor 312 of server computer 310 is configured to include preventable event module 320 that executes techniques of this disclosure with respect to patient healthcare data 330.

Processors 312 and 342 may each comprise a general-purpose microprocessor, a specially designed processor, an application specific integrated circuit (ASIC), a field programmable gate array (FPGA), a collection of discrete logic, or any type of processing device capable of executing the techniques described herein. In one example, memory 314 may store program instructions (e.g., software instructions) that are executed by processor 312 to carry out the techniques described herein. In other examples, the techniques may be executed by specifically programmed circuitry of processor 312. In these or other ways, processor 312 may be configured to execute the techniques described herein.

Output device 316 on client computer 350 may comprise a display screen, and may also include other types of output capabilities. For example, output device 316 may generally represent both a display screen and a printer in some cases. Preventable event module 320 may be configured to cause output device 316 of client computer 350 to output patient healthcare data 330 or processed events 334. User interface 318 may be generated, e.g., as output on a display screen, so as to allow a user enter various selection parameters or other information.

Similar to the stand alone example of FIGS. 1-2, in the distributed example of FIG. 3, preventable event module 320 may determine potentially preventable healthcare events based on patient healthcare data 330 and patient factors 332. Additionally, the other components of FIG. 3 with names similar to components depicted in FIGS. 1-2 may perform similar functions as the components of FIGS. 1-2 as described previously.

In some examples, preventable event module 320 may receive selection input from client computer 350. For example, preventable event module 320 may be configured to receive user input in order to determine the potentially preventable healthcare events. For example, a user may enter selection parameters at user interface (UI) 318. Again, communication interfaces 326 and 352 allow for communication between server computer 310 and client computer 350 via network 340. In this way, preventable event module 320 may execute on server computer 310 but may receive input from client computer 350. A user operating on client computer 350 may log-on or otherwise access preventable event module 320 of server computer 310, such as via a web-interface operating on the Internet or a propriety network, or via a direct or dial-up connection between client computer 350 and server computer 310. In some cases, data displayed on output device 330 may be arranged in web pages served from server computer 310 to client computer 350 via hypertext transfer protocol (HTTP), extended markup language (XML), or the like.

In at least one example, the user input may comprise parameters by which preventable event module 320 determines the potentially preventable healthcare events. A user may specify only certain healthcare providers for which to determine potentially preventable healthcare events. In some examples, preventable event module 320 may be further configured to perform functions similar to preventable comparator module 224 as described in FIG. 2. For example, preventable event module 320 may additionally determine a total number of potentially preventable healthcare events or a rate of potentially preventable healthcare events for each healthcare provider. In other examples, preventable event module 320 may receive selection input directing preventable event module 320 to compare the rates of potentially preventable healthcare events between various healthcare providers. In such an example, preventable event module 320 may determine average rates and determine how each healthcare provider differs from the average.

In at least one example, preventable event module 320 receives patient healthcare data 330. As described previously, patient healthcare data 330 may include information included in a patient healthcare record or any other documents or files describing a patient encounter with a healthcare facility, including medical claims forms. Patient healthcare data 330 may further include one or more standard healthcare codes, such as (ICD) codes (versions 9 and 10), Current Procedural Technology (CPT) codes, Healthcare Common Procedural Coding System codes (HCPCS), and Physician Quality Reporting System (PQRS) codes as described previously. Patient healthcare data 330 may also include other standard healthcare codes such as Diagnostic Related Group (DRG) codes and National Drug Codes (NDCs). These DRG codes may represent a specific category of disease or health problem the patient suffers from or has suffered from in the past if the DRG is associated with a past event.

Preventable event module 320 may then determine potentially preventable healthcare events. For example, preventable event module 320 may determine one or more healthcare events associated with one or more of the received healthcare codes. Preventable event module 320 may further determine one or more patient factors associated with the determined healthcare events. Preventable event module 320 may store these patient factors in memory 314 and/or patient factors 332.

According to techniques of the present disclosure, preventable event module 320 may then determine potentially preventable healthcare events based on the one or more healthcare codes and the one or more determined patient factors. Preventable event module 320 may determine these potentially preventable healthcare events in accordance with the method described previously with respect to preventable event module 120.

Preventable event module 320 may then send, in some examples, in conjunction with user interface module 322, to communication interface 326, through network 340, to communication interface 352, to processor 342, and finally to output device 316. In this way, a user may view the results of the determination of potentially preventable healthcare events.

Additionally, as described above, preventable event module 320 may also perform one or more functions of preventable comparator module 224 as described above. For example, patient healthcare data 330 may further include provider data associating specific healthcare providers with each of the healthcare events. Preventable event module 320 may determine one or more metrics based on the determined potentially preventable healthcare events. Some example metrics include a total number healthcare events a ratio of potentially preventable healthcare events to total healthcare events. In some examples, preventable event module 320 may determine one or more metrics for each individual healthcare provider. For example, preventable event module 320 may determine a ratio of potentially preventable healthcare events to total healthcare events for each individual healthcare provider. Subsequently, preventable event module 320 may determine an average rate of potentially preventable healthcare events and may further determine differences from the average for each individual healthcare provider. As discussed above, these rates and rate variations may be important to healthcare payers in setting or adjusting payment rates, thereby incentivizing healthcare providers with relatively higher rates of potentially preventable healthcare events to try and reduce their rates of potentially preventable healthcare events. Similarly, healthcare providers may use the rates as internal assessments and to push internal initiatives to lower their rates.

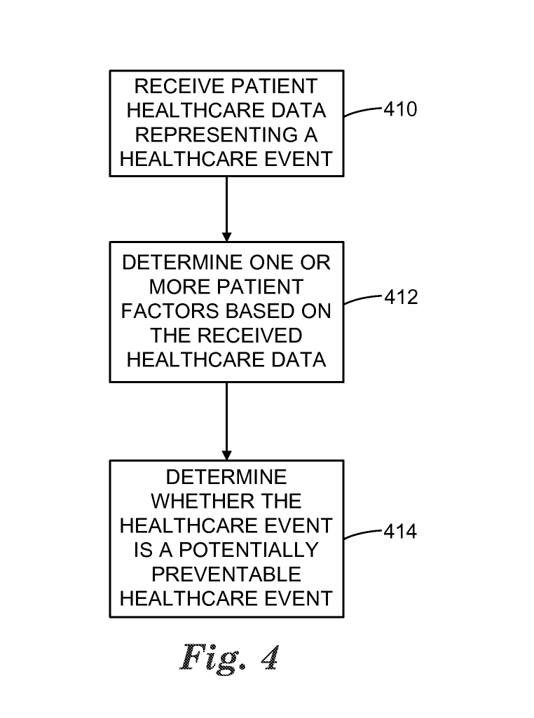

FIGS. 4-7 are flow diagrams illustrating techniques consistent with this disclosure. FIGS. 4-7 will be described from the perspective of computer 110 of FIG. 1, although the system of FIG. 2, or FIG. 3, or other systems could also be used to perform such techniques. As shown in FIG. 4, preventable event module 120 receives patient healthcare data 130 representing a healthcare event (410). Patient healthcare data 130 may include the information described previously with respect to any of the FIGS. 1-3. Preventable event module 120 may also determine one or more patient factors based on the received healthcare data (412). The patient factors may comprise one or more of the stage and extent of any comorbid disease, the location of residence, the type of healthcare event, the recency and sequence of events, and the clinical necessity for the service.

In some examples, preventable event module 120 may further process the received healthcare data 130 in order to determine the stage and extent of any comorbid disease. For example, preventable event module 120 may process patient healthcare data 130 according to the method disclosed in U.S. Pat. No. 7,127,407 to Averill et al. The result of this processing may be one or more codes associated with each healthcare event. Some example codes include DRG/EAPG/CRG and SoI codes. In general, these codes describe the stage and extent of any comorbid disease.

In some examples, patient healthcare data 130 may include one or more healthcare codes that directly indicate a location of residence. In other examples, preventable event module 120 may determine the location of residence based on information included in patient healthcare data 130. For example, patient healthcare data 130 may include health care codes associated with treatment at a semi- or full-service medical facility. In such examples, preventable event module 120 may determine the location of residence to be a semi- or full-service medical facility based on the presence of the one or more codes and if the codes are associated dates occurring in the last 1 day, 3 days, 7 days, or other time period lengths.

In addition to determining the presence and severity of comorbid diseases and a location of residence, preventable event module 120 may also determine a type of healthcare event for each healthcare event. As described previously, each healthcare event may comprise either an inpatient event, an emergency department event, or an ancillary service event. In some examples, preventable event module 120 determines the type of event based on the healthcare codes associated with the particular healthcare event. For example, each of the healthcare codes may be associated with a type of healthcare event, and, based on the healthcare codes and their associations, preventable event module 120 may determine that an event is one of an inpatient event, an emergency department event, or an ancillary service event. In other examples, a specific healthcare code may directly signal whether an event is an inpatient event, an emergency department event, or an ancillary service event.

In some instances, preventable event module 120 may determine one or more additional factors. For example, preventable event module 120 may additionally determine a health status exclusion factor. In other examples, preventable event module 120 may further determine a trauma factor. In at least one example, preventable event module 120 determines a trauma factor if the type of healthcare event comprises an ED type healthcare event.

Preventable event module 120 may then determine whether the healthcare event is a potentially preventable healthcare event (414). Preventable event module 120 may determine whether the healthcare event is a potentially preventable healthcare according to any of the disclosed methods as described herein concerning FIGS. 1-3.

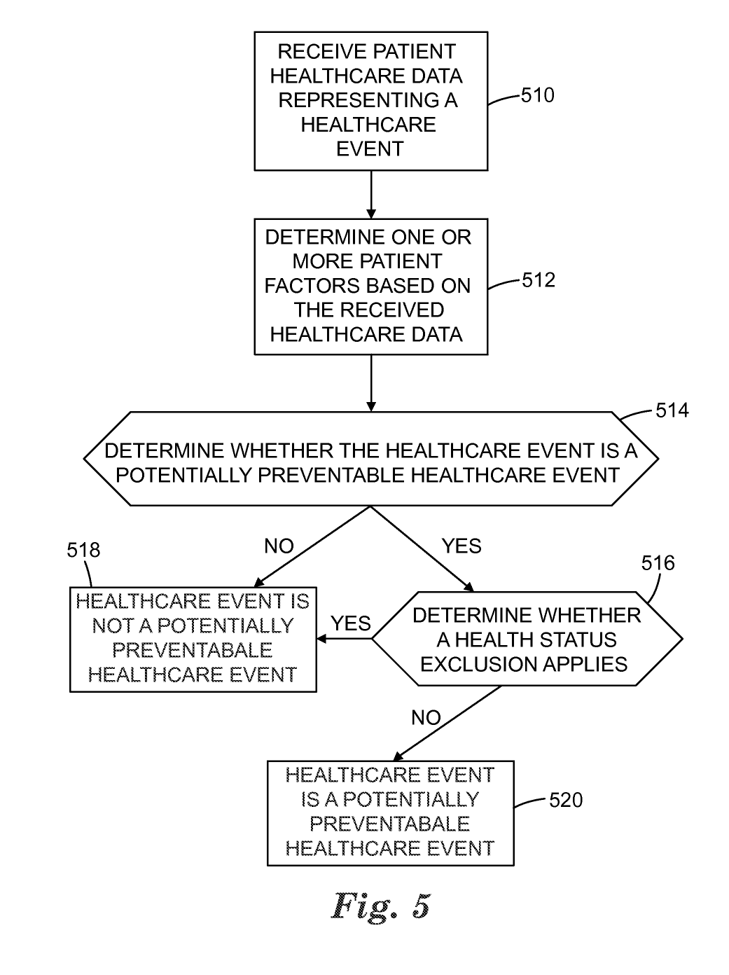

As shown in FIG. 5, preventable event module 120 receives patient healthcare data 130 representing a healthcare event (510). Preventable event module 120 may also determine one or more patient factors based on the received healthcare data (512). Preventable event module 120 may then determine whether the healthcare event is a potentially preventable healthcare event (514). If preventable event module 120 determines that the healthcare event is not a potentially preventable healthcare event (no branch of 514), then the healthcare event is not a potentially preventable healthcare event (518). If preventable event module 120 determines that the healthcare event is a potentially preventable healthcare event (yes branch of 514), preventable event module 120 then determines whether a health status exclusion applies (516).

In some examples, preventable event module 120 determines whether the current healthcare event is excluded from a determination that the healthcare event is a potentially preventable healthcare event based on the health status of the patient. For example, as discussed above, preventable event module 120 may determine one or more DRG/EAPG/CRG and SoI parameters associated with each healthcare event. In general, these parameters may indicate a type and severity of illness of the patient. If the parameters indicate an excessively severe condition, preventable event module 120 determines a positive health status exclusion factor for the current healthcare event. Some examples of excessively severe conditions include metastatic cancers, malignant neoplasms, and severe hypertension, among other severe health conditions. If preventable event module 120 determines that a health status exclusion does apply (yes branch of 516), preventable event module 120 determines that the healthcare event is not a potentially preventable healthcare event (518). If preventable event module 120 determines that a health status exclusion does not apply (no branch of 516), preventable event module 120 determines that the healthcare event is a potentially preventable healthcare event (520).

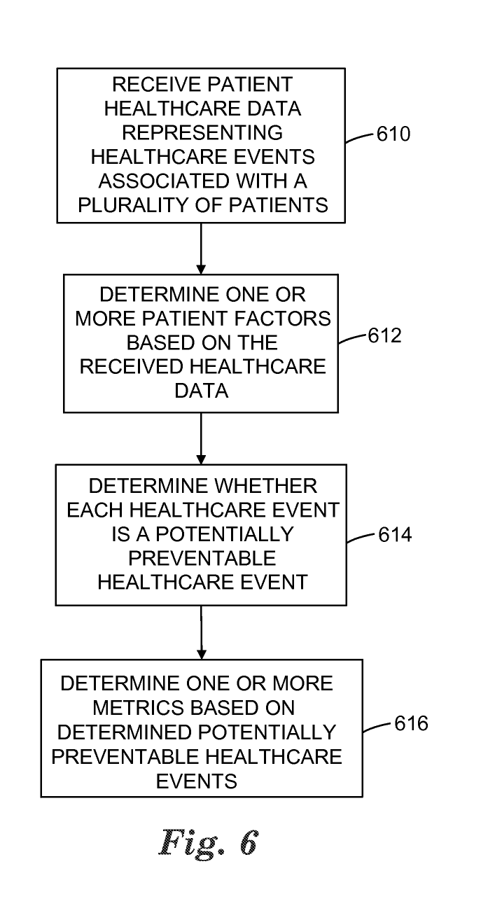

As shown in FIG. 6, preventable event module 120 receives patient healthcare data 130 representing healthcare events associated with a plurality of patients (610). Preventable event module 120 may also determine one or more patient factors based on the received healthcare data (612). Preventable event module 120 may then determine whether each of the plurality of healthcare events is a potentially preventable healthcare event (614). Finally, preventable event module 120 determines one or more metrics based on the determined potentially preventable healthcare event (616). For example, preventable event module 120 may determine a total number of potentially preventable healthcare events associated with each specific healthcare provider. In other examples, preventable event module 120 may determine a percentage of potentially preventable healthcare events to total healthcare events for a specific healthcare provider. In at least one example, preventable event module 120 may determine rates of potentially preventable healthcare events of a particular type, i.e. inpatient admission event, ancillary service event, and ED event. In other examples, preventable event module 120 may determine rates of potentially preventable healthcare events for a particular disease. In still other examples, preventable event module 120 may compare the determined rates of potentially preventable healthcare events between multiple providers. In still other examples, preventable event module 120 may determine an average rate of potentially preventable healthcare events across all healthcare providers, or only selected healthcare providers, and may further determine differences from the average for each individual healthcare provider.

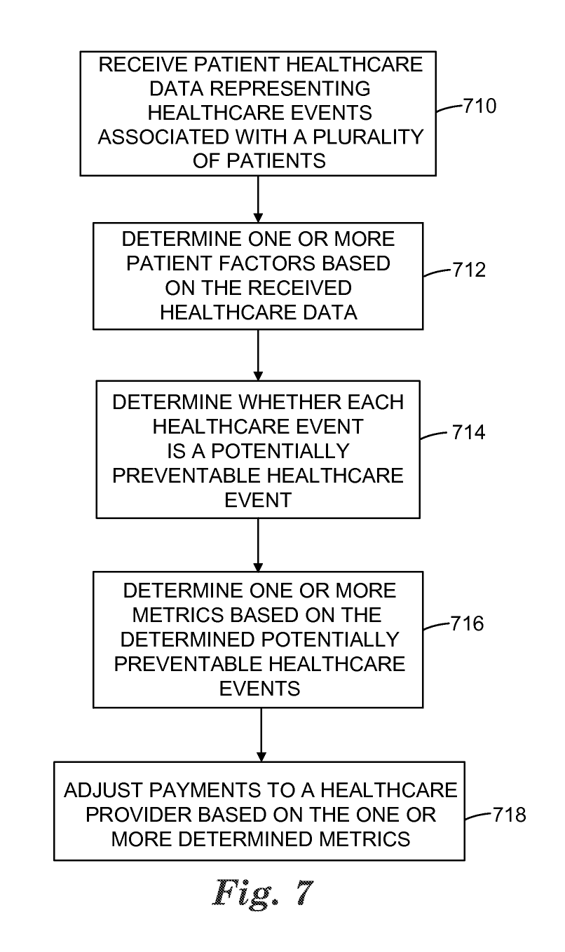

As shown in FIG. 7, preventable event module 120 receives patient healthcare data 130 representing healthcare events associated with a plurality of patients (710). Preventable event module 120 may also determine one or more patient factors based on the received healthcare data (712). Preventable event module 120 may then determine whether each of the plurality of healthcare events is a potentially preventable healthcare event (714). Preventable event module 120 determines one or more metrics based on the determined potentially preventable healthcare event (716). Finally, preventable event module 120 determines an adjusted payment to a healthcare provider based on the one or more determined metrics. For example, in some instances where the metric may be the rate of potentially preventable healthcare events compared to an average rate of potentially preventable healthcare events, payers may wish to incentivize healthcare providers to reduce their rate of potentially preventable healthcare events. The payers may do this by adjusting payments to the healthcare providers based on their rate. Conversely, the health provider may wish to determine and track their rate of potentially preventable healthcare events in order to implement internal procedures to reduce the rate. In some instances, this will assist the healthcare provider in not receiving lower adjusted payments because of high rates of potentially preventable healthcare events.

The techniques of this disclosure may be implemented in a wide variety of computer devices, such as servers, laptop computers, desktop computers, notebook computers, tablet computers, hand-held computers, smart phones, and the like. Any components, modules or units have been described to emphasize functional aspects and does not necessarily require realization by different hardware units. The techniques described herein may also be implemented in hardware, software, firmware, or any combination thereof. Any features described as modules, units or components may be implemented together in an integrated logic device or separately as discrete but interoperable logic devices. In some cases, various features may be implemented as an integrated circuit device, such as an integrated circuit chip or chipset. Additionally, although a number of distinct modules have been described throughout this description, many of which perform unique functions, all the functions of all of the modules may be combined into a single module, or even split into further additional modules. The modules described herein are only exemplary and have been described as such for better ease of understanding.

If implemented in software, the techniques may be realized at least in part by a computer-readable medium comprising instructions that, when executed in a processor, performs one or more of the methods described above. The computer-readable medium may comprise a tangible computer-readable storage medium and may form part of a computer program product, which may include packaging materials. The computer-readable storage medium may comprise random access memory (RAM) such as synchronous dynamic random access memory (SDRAM), read-only memory (ROM), non-volatile random access memory (NVRAM), electrically erasable programmable read-only memory (EEPROM), FLASH memory, magnetic or optical data storage media, and the like. The computer-readable storage medium may also comprise a non-volatile storage device, such as a hard-disk, magnetic tape, a compact disk (CD), digital versatile disk (DVD), Blu-ray disk, holographic data storage media, or other non-volatile storage device.

The term “processor,” as used herein may refer to any of the foregoing structure or any other structure suitable for implementation of the techniques described herein. In addition, in some aspects, the functionality described herein may be provided within dedicated software modules or hardware modules configured for performing the techniques of this disclosure. Even if implemented in software, the techniques may use hardware such as a processor to execute the software, and a memory to store the software. In any such cases, the computers described herein may define a specific machine that is capable of executing the specific functions described herein. Also, the techniques could be fully implemented in one or more circuits or logic elements, which could also be considered a processor.

These and other examples are within the scope of the following claims.

What is claimed:

1. A method of processing patient healthcare data, via one or more computers, the method comprising:
receiving, at the one or more computers, patient healthcare data, wherein the patient healthcare data represents a healthcare event and includes one or more healthcare codes;
determining, by the one or more computers and based on the one or more healthcare codes, one or more patient factors associated with the healthcare event; and
determining, by the one or more computers and based on the one or more healthcare codes and the one or more determined patient factors associated with the healthcare event, whether the healthcare event is a potentially preventable healthcare event,
wherein the healthcare event comprises one of:
an inpatient admission;
an emergency room visit; and
an outpatient ancillary service.

2. The method of claim 1, wherein a potentially preventable healthcare event is a healthcare event associated with one or more healthcare codes and one or more determined patient factors which are consistent with a preventable healthcare event.

3. The method of claim 1, wherein determining whether the healthcare event is a potentially preventable healthcare event comprises:
determining, by the one or more computers and based on the one or more healthcare codes and the one or more determined patient factors associated with the healthcare event, a first determination of whether the healthcare event is a potentially preventable healthcare event;
determining, by the one or more computers and based on the one or more healthcare codes and the one or more determined patient factors associated with the healthcare event, whether a health status exclusion applies to the healthcare event; and
determining, by the one or more computers and based on the one or more healthcare codes associated with the healthcare event, the one or more determined patient factors associated with the healthcare event, and whether a health status exclusion applies to the healthcare event, a second determination of whether the healthcare event is a potentially preventable healthcare event.

4. The method of claim 1, wherein the one or more determined patient factors comprise one or more of:
a stage and extent of comorbid disease factor;
a location of residence factor;
a type of healthcare event factor;
a sequence of services factor; and
a clinical necessity for service factor.

5. The method of claim 1, wherein receiving patient healthcare data comprises receiving patient healthcare data associated with a plurality of patients,
wherein the patient healthcare data associated with the plurality of patients represents a plurality of healthcare events and one or more healthcare codes associated with each of the plurality of healthcare events,
wherein determining one or more patient factors comprises determining one or more patient factors associated with each of the plurality of healthcare events; and
wherein determining whether the healthcare event is a potentially preventable healthcare event comprises determining whether each of the plurality of healthcare events is a potentially preventable healthcare event.

6. The method of claim 5, wherein determining whether each of the plurality of healthcare events is a potentially preventable healthcare event comprises:
determining, by the one or more computers and based on the one or more healthcare codes and the one or more determined patient factors associated with each of the plurality of healthcare events, a first determination of whether each of the plurality of healthcare events is a potentially preventable healthcare event;
determining, by the one or more computers and based on the one or more healthcare codes and the one or more patient factors associated with each of the plurality of healthcare events, whether a health status exclusion applies for each of the plurality of healthcare events; and
determining, by the one or more computers and based on the one or more healthcare codes associated with each of the plurality of healthcare events, the one or more determined patient factors associated with each of the plurality of healthcare events, and whether a health status exclusion applies for each of the plurality of healthcare events, a second determination of whether each of the plurality of healthcare events is a potentially preventable healthcare event.

7. The method of claim 5, further comprising comparing the determined potentially preventable healthcare events to a total number of healthcare events.

8. The method of claim 7, further comprising adjusting a payment or payments based on the comparison of the determined potentially preventable healthcare events to the total number of healthcare events.

9. The method of claim 5, wherein the patient healthcare data further comprises provider data associated with each of the plurality of healthcare events, wherein the provider data comprises one or more healthcare service providers.

10. The method of claim 9, further comprising comparing the determined potentially preventable healthcare events associated with one or more healthcare service providers to a total number of healthcare events associated with the one or more healthcare service providers.

11. The method of claim 9, further comprising adjusting a payment or payments to the one or more healthcare service providers based on the comparison of the determined potentially preventable healthcare events to the total number of healthcare events.

12. A computerized healthcare system for processing healthcare data, the system comprising a computer that includes a processor and a memory, wherein the processor is configured to:
receive patient healthcare data, wherein the patient healthcare data represents a healthcare event and includes one or more healthcare codes;
determine, based on the one or more healthcare codes, one or more patient factors associated with the healthcare event; and
determine, based on the one or more healthcare codes and the one or more determined patient factors associated with the healthcare event, whether the healthcare event is a potentially preventable healthcare event,
wherein the healthcare event comprises one of:
an inpatient admission;
an emergency room visit; and
out an patient ancillary service.

13. The system of claim 12, wherein a potentially preventable healthcare event is a healthcare event associated with one or more healthcare codes and one or more determined patient factors which are consistent with a preventable healthcare event.

14. The system of claim 12, wherein the processor is further configured to:
determine, based on the one or more healthcare codes and the one or more determined patient factors associated with the healthcare event, a first determination of whether the healthcare event is a potentially preventable healthcare event;
determine, based on the one or more healthcare codes and the one or more determined patient factors associated with the healthcare event, whether a health status exclusion applies to the healthcare event; and
determine, based on the one or more healthcare codes associated with the healthcare event, the one or more determined patient factors associated with the healthcare event, and whether a health status exclusion applies to the healthcare event, a second determination of whether the healthcare event is a potentially preventable healthcare event.

15. The system of claim 12, wherein the one or more determined patient factors comprise one or more of:
a stage and extent of comorbid disease factor;
a location of residence factor;
a type of healthcare event factor;
a recency and sequence of events factor; and
a clinical necessity for service factor.

16. The system of claim 12, wherein the processor is further configured to:
receive patient healthcare associated with a plurality of patients, wherein the patient healthcare data associated with the plurality of patients represents a plurality of healthcare events and one or more healthcare codes associated with each of the plurality of healthcare events;
determine one or more patient factors comprises determining one or more patient factors associated with each of the plurality of healthcare events; and
determine whether the healthcare event is a potentially preventable healthcare event comprises determining whether each of the plurality of healthcare events is a potentially preventable healthcare event.

17. The system of claim 16, wherein the processor is further configured to:
determine, based on the one or more healthcare codes and the one or more determined patient factors associated with each of the plurality of healthcare events, a first determination of whether each of the plurality of healthcare events is a potentially preventable healthcare event;
determine, based on the one or more healthcare codes and the one or more determined patient factors associated with each of the plurality of healthcare events, whether a health status exclusion applies for each of the plurality of healthcare events; and
determine, based on the one or more healthcare codes associated with each of the plurality of healthcare events, the one or more determined patient factors associated with each of the plurality of healthcare events, and whether a health status exclusion applies for each of the plurality of healthcare events, a second determination of whether each of the plurality of healthcare events is a potentially preventable healthcare event.

18. The system of claim 16, wherein the processor is further configured to:
compare the determined potentially preventable healthcare events to a total number of healthcare events.

19. The method of claim 18, wherein the processor is further configured to:
adjust a payment or payments based on the comparison of the determined potentially preventable healthcare events to the total number of healthcare events.

20. The system of claim 16, wherein the patient healthcare data further comprises provider data associated with each of the plurality of healthcare events, wherein the provider data comprises one or more healthcare service providers.

21. The system of claim 20, wherein the processor is further configured to:
compare the determined potentially preventable healthcare events associated with one or more healthcare service providers to a total number of healthcare events associated with the one or more healthcare service providers.

22. The system of claim 21, wherein the processor is further configured to:
adjust a payment or payments to the one or more healthcare service providers based on the comparison of the determined potentially preventable healthcare events to the total number of healthcare events.

23. A device for processing healthcare data, the device comprising:
means for receiving patient healthcare data, wherein the patient healthcare data represents a healthcare event and includes one or more healthcare codes;
means for determining, based on the one or more healthcare codes, one or more patient factors associated with the healthcare event; and
means for determining, based on the one or more healthcare codes and the one or more patient factors associated with the healthcare event, whether the healthcare event is a potentially preventable healthcare event,
wherein the healthcare event comprises one of:
an inpatient admission;
an emergency room visit; and
an outpatient ancillary service.

24. A computer readable storage medium comprising instructions that when executed in a processor cause the processor to process healthcare data, wherein upon execution the instructions cause the processor to:
receive patient healthcare data, wherein the patient healthcare data represents a healthcare event and includes one or more healthcare codes;
determine, based on the one or more healthcare codes, one or more patient factors associated with the healthcare event; and
determine, based on the one or more healthcare codes and the one or more patient factors associated with the healthcare event, whether the healthcare event is a potentially preventable healthcare event,
wherein the healthcare event comprises one of:
an inpatient admission;
an emergency room visit; and
an outpatient ancillary service.
